(19) United States
(12) Patent Application Publication
(10) Pub. No.: US 2013/0214919 A1
(43) Pub. Date: Aug. 22, 2013

(54) SEATBELT USAGE LOGGING AND ALERTING SYSTEM

(71) Applicant: Fred Bassali, Great Neck, NY (US)

(72) Inventor: Fred Bassali, Great Neck, NY (US)

(21) Appl. No.: 13/400,200

(22) Filed: Feb. 20, 2012

(51) Int. Cl. B60Q 1/00; G06F 7/00

(52) U.S. Cl. 340/457.1; 701/1

(57) ABSTRACT

A system is provided for logging failures of using seatbelts by occupants of a motor vehicle. The system includes a digital processor, a non-volatile memory, an odometer/speedometer, a clock circuit, seatbelt sensors and a passenger occupancy sensors data. The digital processor utilizes data from the odometer/speedometer for determining the distances travelled by the motor vehicle while occupants were not using seatbelts. The non-volatile memory is configured to record logs for the failures. The digital processor utilizes data from the clock circuit for counting the total times while one or more occupants were not using their seatbelts. The odometer/speedometer verifies that the failures occurred while the motor vehicle was in motion.

### BACKGROUND

1. Field of the Invention

The present arrangement relates to automotive seatbelt systems and means to alert the non-compliant passengers to use their seatbelts and methods to motivate use of seatbelt and schemes for penalizing seatbelt violators and means for monitoring use of seatbelts.

2. Description of Related Art

A seatbelt also referred to as a safety belt, is a safety harness designed to secure the occupant of a motor vehicle against harmful movements that may result in from collisions.

Various statistics show that use of seatbelts reduces the personal injuries and consequent insurance claims [E.g., WORLD STATUS REPORT ON ROAD TRAFFIC INJURY PREVENTION, pp. 32].

Various regions, i.e., countries, states, localities and provinces have different seatbelt laws. For example at the time of this filing, all the states in the US except New Hampshire have mandatory seatbelt laws. Likewise, seatbelt laws are different worldwide. Some localities require only the front passengers to fasten seatbelts while other localities require that all occupants fastening their seatbelts. Nonetheless, passengers of motor vehicles often fail to fasten seatbelts partly because either of lack of concern or lack of familiarity with the local seatbelt law.

Seatbelt violations enforcement is performed by police by issuing summonses which necessitates spotting, chasing, pulling over the violators' vehicles. Spotting drivers who do not use seatbelts is difficult due inadequate visibility of inside vehicles from the remote. Ironically, police vehicle pullovers pose risks of accidents, cause traffic slowdowns and are in contradiction to the public safety which is the goal of seatbelt use. A safer and more effective approach for seatbelt violation enforcement is necessary.

### OBJECTS AND SUMMARY OF THE INVENTION

Use of seatbelts is well-known for reducing accident related fatality and injury rates, however, passengers often fail to fasten their seatbelts. Deployment of the present invention in the automobiles motivates the passengers of motor vehicles for using seatbelts in order to maintain a good seatbelt compliance record for lower insurance premiums and government imposed penalties.

The present invention is comprised of a system which generates the log of failures of using seatbelt. According to a preferred embodiment, the system recognizes each passenger who is not using seatbelt and passengers are individually alerted via different means, i.e., warning lights and/or voice and/or mechanical vibrations.

Different methods for individually alerting the passengers to use the seatbelt are utilized according to the present invention: (i) Seatbelt warning lights are installed on a single or a plurality of designated panels or on seatbelt buckles, (ii) A synthesized human voice or pre-recorded voice alerts the passengers individually to fasten their seatbelts, (iii) A pulsating vibration is generated by a mechanical vibrator in each passenger seat or in each seatbelt receiver.

The travel data produced by the odometer/speedometer in conjunction with the data collected from occupancy and seatbelt sensors are utilized in order to compile the logs of mileage/times of failures to use of seatbelts.

Different states/regions have different seatbelt. Some states require use of seatbelt for only the front passengers whereas other states require use of seatbelt for all passengers or none of the passengers. According to one of the embodiments of the present invention, the system distinguishes between the two different incidences of failure to use the seatbelt: (i) When the local law requires use of seatbelt. (ii) When the local law does not require use of seatbelt.

A GPS receiver is utilized in the present invention for: (i) Generating the travel data. (ii) Determining the applicable seatbelt regional laws, i.e., to establish whether failure to fasten seatbelt constituted the violation of regional law.

In another embodiment of the present invention, both data generated from a GPS and a speedometer/odometer are utilized wherein the data from the GPS receiver is merely used for identifying the geographic location for determining the applicable seatbelt law. Since in certain locations such as tunnels, parking lots there is no GPS reception, data generated by a speedometer/odometer is utilized.

The log of failures to fasten seatbelt is useable for assessment of insurance premiums, whereas, the seatbelt violation log is useable by the departments of motor vehicles (DMVs) or possibly other governmental entities for imposing violation penalties or taxes or any other purpose. According to the present invention these information are available on the vehicle's display screen in real time: (i) Logs of failures to fasten seatbelt. (ii) Seatbelt violation. (iii) A log of accrued seatbelt penalties to-date. (iv) Seatbelt usage status. (v) Vehicles identification information. The same information is available via wireless access. According to one of the embodiments, the logs of failure to use seatbelt and accrued penalties are accessible via wireless networks. In another embodiment a transponder is utilized wherein upon receiving an interrogation signal, a reply containing the pertinent information is generated by the transponder.

### BRIEF DESCRIPTION OF DRAWINGS

FIG. 1 depicts a block diagram of a seatbelt usage system wherein the travel data generated by vehicle's odometer/speedometer.

FIG. 2 depicts a block diagram of a seatbelt usage system wherein a GPS receiver is utilized for dual purpose, i.e., generating the travel data and identifying the geographic region for determining the applicable law.

FIG. 3 depicts a block diagram of a seatbelt usage system wherein, both, a GPS receiver and an odometer/speedometer are utilized, whereas the GPS is used for identifying the locality for determining the applicable law and the travel data are generated by odometer/speedometer.

FIG. 4 depicts an overhead console of a vehicle equipped with 5 different warning lights implemented above the rear view mirror, wherein each light is designated for alerting each of passengers individually when the seatbelt is not used.

FIG. 5 depicts the interior a vehicle wherein two separate overhead consoles equipped with seatbelt warning lights for front and rear passengers are utilized.

FIG. 6 depicts the interior a vehicle wherein two separate consoles equipped with seatbelt warning lights for front and rear passengers are utilized. Theses consoles are placed at a lower level than the consoles of FIG. 5. The console for the front passengers is implemented on the dashboard and the console for the rear passengers is implemented on the vehicle's center console.

FIG. 7 depicts the interior a vehicle wherein two seatbelt warning lights for the front passengers are implemented on the dashboard, one in front of the driver seat and another in front of front passenger seat and similarly, for alerting the rear passengers, warning lights are implemented on the back of front passenger seats and center console.

FIG. 8 depicts an implementation of a seatbelt warning light on the seatbelt receiver (seatbelt female module).

FIG. 9 depicts an implementation for a possible mechanical vibrating mechanism installed inside passengers seats or seatbelt receiver for alerting non-compliant passengers to use their seat belts.

FIG. 10 depicts a computer generated log of failures to fasten seatbelt and the status of seatbelts usage.

FIG. 11 depicts a computer generated log of failures to fasten seatbelt in conjunction with log of seatbelt violations wherein there are separate categories for the home state and other states where seatbelt violations had occurred.

FIG. 12 depicts a series of computer generated logs similar to the logs of FIG. 11 wherein durations and distances travelled with seatbelt violations for each of the states and the calculated penalties/taxes accrued to date.

FIG. 13 depicts a fractional block diagram for the present invention wherein wireless access is added to the systems described in the block diagrams of FIGS. 1, 2 and 3. According to this implementation a transceiver similar to those used in cellular telephones or satellite phones is added to the block diagrams of FIGS. 1, 2 and 3 and the wireless communication can established via cellular networks and/or satellites.

FIG. 14 depicts a fractional block diagram of the present invention similar to depiction of FIG. 13 using a different form of wireless access, i.e., the wireless communication is established via a special transponder which replies to the interrogation signals from beacon transmitters, wherein the beacon transmitter is typically operated by police, motor vehicle inspection stations and insurance agents.

FIG. 15 depicts a typical report generated by police's beacon radar which is by incorporating the transponder replies from the close by vehicles and is displayed on the display screen in police's vehicles.

### DESCRIPTION OF THE PREFERRED EMBODIMENTS

Different mechanism are utilized for sensing whether a passenger is using seatbelt. In one of the methods, a sensor is implemented at the pulley which the seatbelt strap is are rolled around it sensing that the pulley is retracted. This is done by utilizing gears and use of electrical contact for or optical sensing for the engaged gear. In another method a sensing mechanism is implemented at the seatbelt receiver. i.e., a seatbelt is fastened by inserting a metallic tab (male module) into a receiver (female module). A seatbelt receiver is commonly equipped with a built-in sensor which senses whether the seatbelt is buckled or not. Different sensing mechanisms are utilized, e.g., optical sensors wherein a beam of light is blocked when the tab is inserted in the receiver, or mechanical switch which is activated/deactivated when the tab is inserted into the receiver (i.e., change from an open circuit to a short circuit or vice versa) corresponding to the change of binary state of the seatbelt sensor output. Car seats contain passenger occupancy sensors and based on the presence or absence of passenger an occupancy sensor produces a binary output. A variety of techniques are utilized for implementing occupancy sensors, e.g., infra red sensors, tension sensors, capacitance sensors, inductor sensors. Outputs of a seatbelt sensor together with the pertinent passenger occupancy sensor are utilized for verifying seatbelt use.

The present invention utilizes data from seatbelt sensors in conjunction with the passenger occupancy sensors. When a passenger does not use the seatbelt he/she individually is prompted to fasten seatbelt. Furthermore, Status Reports including logs of seatbelt violation mileage/time and seatbelt usage failures are generated on a periodic basis. Such Status Reports assist insurance companies to obtain a more reliable assessment of insurance premiums. Also, the annual logs of lack of use of seatbelts or seatbelt violations are utilizable by the Departments of Motor Vehicles and/or other government agencies to impose penalties or some form of seatbelt violation.

According to an embodiment of the present invention, an overhead console which is visible by all passengers and includes warning lights for each passenger is utilized. In a different embodiment, separate overhead consoles for front and rear passengers are utilized. In another embodiment, there is a designated warning light in front of every passenger. According to one of the embodiments of the present invention, warning lights are incorporated in the seatbelt receiver (female buckle).

In addition to warning lights, a sound device, producing a chime, buzzing sound can further alert the passenger. In a preferred embodiment of the present invention a synthesized/recorded human voice alerts the particular passenger for failure to fasten seatbelt. This can be implemented in a variety of techniques. In a possible implementation recordings from human voice are utilized wherein different messages for different situations are recorded and digitized and saved in nonvolatile memory and retrieved from the memory as necessary. Depending on the format, the digitization could be of pulse width modulation format in which conversion to analog voice is performed simply by use of a low pass filter (LPF) and an audio amplifier. However, when digitization is done by the traditional analog to digital convertor (ADC), the digital signal is converted back to analog by use of a digital to analog converter (DAC). In another possible implementation of alerting by voice, a voice synthesizer is utilized. A designated speaker for alerting or the same speaker used for vehicle's sound system is utilized. According to this embodiment of the present invention, for every seat there is a separate message, e.g., the human voice announces: “Rear left passenger has not fastened seatbelt”. Also, when there is violation of the state/local law, the combination of messages clarify the occurrence of such, e.g.,: “Rear left passenger has not fastened seatbelt. State/local law requires use of passenger by the passengers in the rear seats.”

According to another embodiment of the present invention, for reminding passengers to use their seatbelts, a mechanical vibration transducer is implemented in the seat or in the seatbelt receiver, whereas the transducer can be a mechanical vibrator, a piezoelectric device, a speaker or a similar mechanism. Depending on the position, vibrations generated by a vibrating mechanism in a seatbelt receiver might not be sensible by the passengers, however, the buzzing sound generated from the vibrations is usually sufficiently loud for alerting the passenger. According to the preferred embodiment, the vibrations are non continuous (intermittent). Furthermore, in order to distinguish between the failures of fastening the seatbelt when is required by local law and when is not required by the local law, the vibrations are at different rates, i.e., the pertinent vibrating mechanism is turned on and off at different rates.

A system built according to the present invention generates and records the logs of mileage and/or times during the occurrences of the failure to use seatbelt and seatbelt violations. The system uses a penalty schedule possibly mandated by locality or localities in order to determine the total up to date files. The penalty is calculated based on the total duration or distances that the vehicle has travelled with seatbelt violations. The system generates the logs of penalties which can be viewed by the user on vehicles display screen in the real time. These logs are also accessible via a special port or the vehicles computer port at the annual auto inspection performed by inspection stations or insurance companies.

Based on the total mileage/time that a vehicle has been driven with seatbelt violation a penalty schedule could be applied by the pertinent governmental entities. Either a mileage or time tariff per seat or a combination of both could be imposed, e.g., a penalty schedule of $0.02 per passenger per mile and/or a penalty of $0.30 per passenger per hour.

In a possible scenario, at the yearly auto inspection, the inspection station accesses the logs of failures to fasten seatbelts, seatbelt violations, penalties and accrued penalties to date and sends the information to DMV (Department of Motor Vehicle) and auto insurance companies. Once that information is submitted to the pertinent entities, the logs are reset to zero. In order to renew inspection or registration, the seatbelt violation penalties are collected either by the inspection station and sent to the pertinent government entity or alternatively the pertinent government entity sends an invoice/statement for the penalties incurred as a result of seatbelt violations to the registrant of the vehicle. The logs of failures to use seatbelts and/or seatbelt violations generated by utilizing of the present invention are usable by insurance carriers for assessing the insurance premiums. Similarly the insurance companies asses new insurance premiums based of the logs of failures to fasten seatbelts and sends a statement/invoice for the insurance renewal.

According to a preferred embodiment of the present invention two distinct colors (e.g., red and yellow) are used for indicating whether failure to fasten seatbelt is violating the state/regional law or only failure of to fasten seatbelt is not in violation of seatbelt local law.

According another preferred embodiment of the present invention two distinct blinking rates slow and fast are used for indicating whether failure to fasten seatbelt is violating the state/regional law or only failure of to fasten seatbelt did not violate the local law. Additionally both embodiments, i.e., different colors (e.g., red and yellow) and different blinking rates can be utilized for indicating whether failure to fasten seatbelt is violating the state/regional law or only failure of to fasten seatbelt did not violate the local law.

Typically in a modern day motor vehicle, in order to deliver travel/velocity data to the dashboard instrument cluster a drive cable is utilized. As the vehicle travels and the drive shaft rotates, the center wire in the drive cable rotates and delivers the travel data to the odometer/speedometer in the dashboard instrument cluster. In a typical situation, for every mile that the vehicle travels the drive cable rotates 1000 times generating n×1000 electrical pulses, where n is an integer which corresponds to the number of detecting mechanisms at the end of drive cable. The total number of pulses corresponds to travelled distance and the pulse rate (number of pulses per unit time) corresponds to the velocity (speedometer) data.

In some vehicles different schemes in which number of pulses does not correspond to travelled distance are utilized. For instance, in a different method, speedometer generates an analog voltage which has a linear relationship with the vehicle's instantaneous velocity. This voltage is continuously converted into digital format by an analog to digital converter (ADC) producing binary data. In order to demonstrate the general concept of the present invention, despite the differences in the signal processing for the different formats of travel data, the general term of “Odometer/Speedometer” data is used.

Another method for generating the travel data is by use of a GPS receiver. A GPS receiver can be used for generating travel data, as well as for applying the pertinent seatbelt law GPS data is used for identifying the state/locality where the vehicle is driven. However, GPS receivers do not work in the tunnels and in door locations. Hence use of an odometer/speedometer instead of a GPS receiver for producing travel data has an advantage.

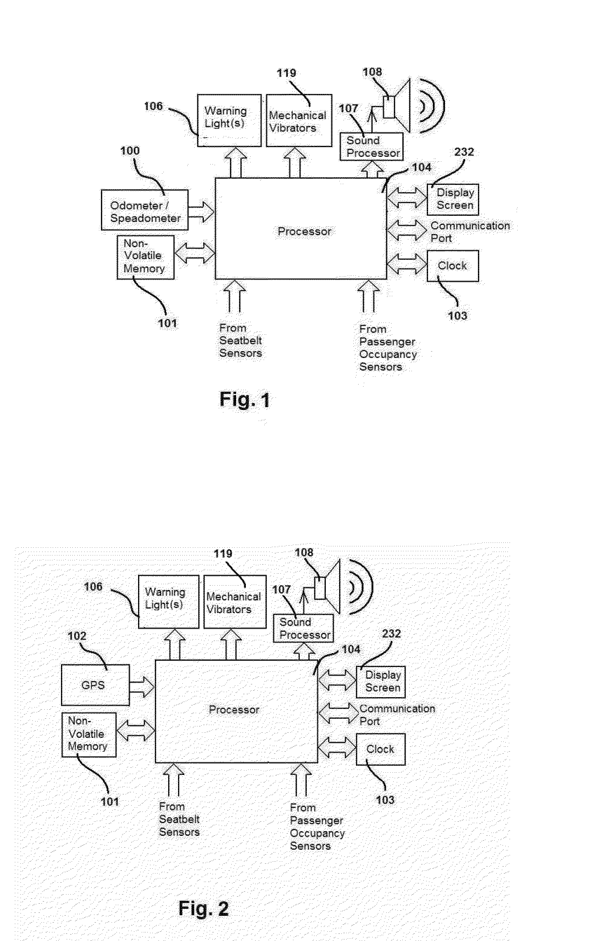

FIG. 1 depicts the block diagram for a possible implementation of the present invention wherein the seatbelt sensors data and the passenger occupancy sensors data are inputted to processor 104. Processor 104 is a digital circuit that handles data processing in real time and may be a implemented using a variety of designated digital hardware, e.g., micro-controller, microprocessor, digital signal processor, FPGA, PLA, PLD, CPLD, sequential logic circuit or the vehicle's computer may be utilized.

Clock 103 is connected via a bus to processor 104 for supplying the timing and date information. In configuration of block diagram of FIG. 1, the clock/timing data and dates generated by clock 103 has several uses: (i) Timing reference for Processor 104. (ii) Calendar date and time for to be used as log of events. (iii) Timing reference for blinking warning lights 106. (iv) Timing reference for speech synthesis to feed speaker 108.

Non-Volatile memory 101 is connected via a bus to processor 104 and is used for storing: (i) Program running processor 104. (ii) Log of events, i.e., failures to use seatbelts with their associated times and odometer information. (iii) Timing reference for odometer/speedometer 100 data to determine vehicle's velocity and distance. (iv) Voice synthesis messages to be played by speaker 108.

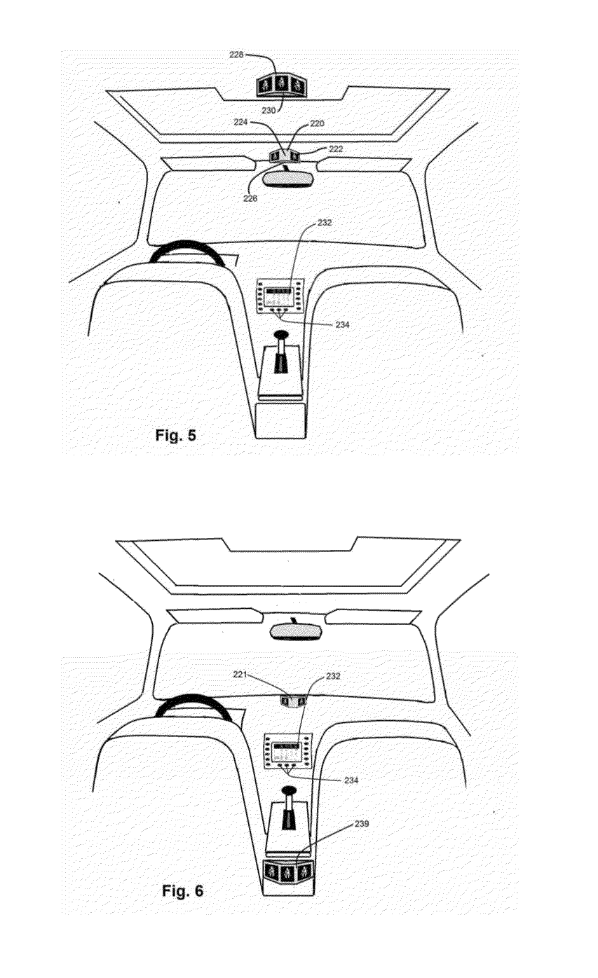

As depicted in FIG. 1, both the seatbelt sensors data and the passenger occupancy sensors data are utilized. Processor 104 determines which passenger(s) is/are not using seatbelt(s). Upon the determination that a passenger is not fastening the seatbelt, the pertinent warning light 106 is turned on with a solid illumination or blinking, whereas as described below, warning lights may be implemented in a variety of schemes, e.g., FIGS. 4, 5 and 6.

Odometer and/or speedometer 100 supplies the travel data to processor 104. whenever processor 104 detects a failure of seatbelt use (i.e., passenger occupancy sensor detects presence of passenger on the seat but the seatbelt sensor detects that the seatbelt is not buckled) the odometer initial mileage and final mileage data, and the initial and final time that the seatbelt is not used and the identity of the seat are recorded in non-volatile memory.

Upon the determination that a passenger is not using seatbelt, processor 104 turns on the pertinent warning light 106 and/or mechanical vibrators 119 and/or the pertinent voice messages are retrieved from non-volatile memory 101, the sound message data is provided to sound processor 107 which in turn provides an analog voice signal to speaker 108. Mechanical vibrators 119 are also means for reminding passengers to use their seatbelts. These devices are implemented in the passengers' seats or the pertinent seatbelt receivers for alerting non compliant passenger by giving a sense of vibration and/or sound generated by vibrations. Depending on the digital format of the sound, sound processor 107 can have different configurations. If the digital voice data is constructed by pulse width modulation, sound processor 107 is composed of a low pass filter and an audio amplifier, whereas if the digital voice data is constructed by use of an ADC, sound processor 107 is composed of a DAC followed by an audio amplifier.

For each passenger who is not using the seatbelt, processor 104 records the information accumulatively. This information is saved in a table in which the total time and/or distance while seatbelt was not used as the vehicle was in motion is documented.

Display screen 232 screen is connected via a bus to processor 104. It could be standard display screen used for vehicle's utilities such as GPS, car radio, CD player, camera, collision avoidance radar, etc. Alternatively, display screen 232 could be an independent display. Pluralities of control keys for controlling different functions of display screen 232 contains are placed on the perimeter of display screen 232 and are in communication with processor 104. When display screen 232 is in use for the functions related to the present invention, information such as seatbelt use or different logs regarding the failures of seatbelt use are displayed.

The scheme described in FIG. 1 can only determine failures to fasten seatbelt without determining whether any of the failures were in violation of the regional laws.

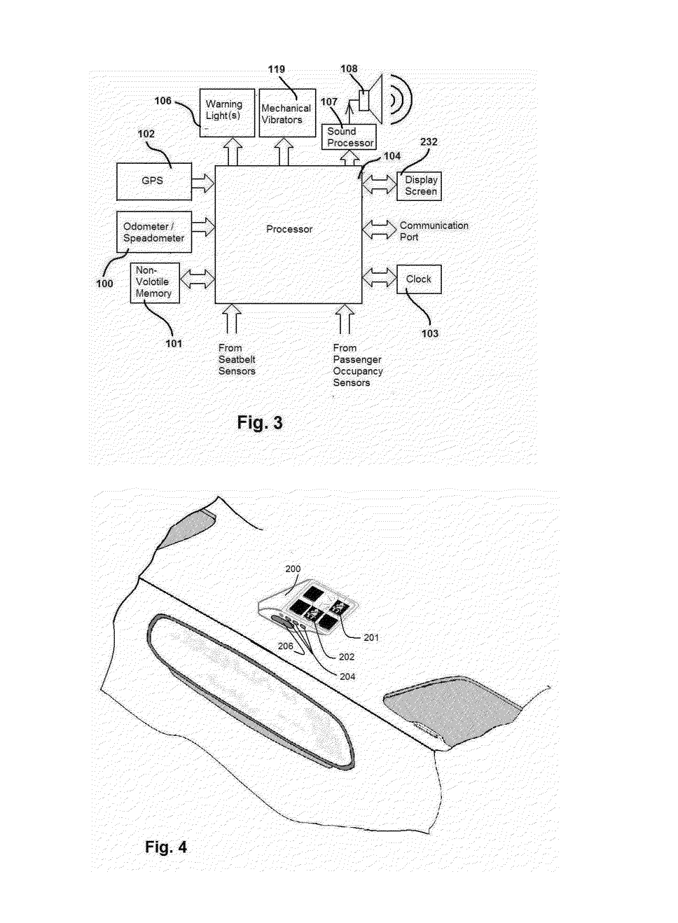

In the systems with described in FIG. 2 and FIG. 3, the table of different state/regional seatbelt laws is stored in non volatile memory 101. This table includes whether in the each state/region all passengers or only front passenger or none of passengers are required to fasten seatbelts. In a possible scenario when seatbelts are not used, the GPS determines the location for applying the appropriate state/regional law.

Regardless of whether state/regional law is violated or not, the system also records all failures of using seatbelts in order for the future use by entities such as insurance companies. The log of failure to fasten seatbelts and seatbelt violations is stored in non-volatile memory 101 and retrieved when the system accessed.

In a possible scenario, at the annual automobile inspection, the violation log and the failure to use the seatbelt are accessed by the inspection station and sent to the Department of Motor Vehicles (DMV) or other pertinent governmental entities as well as the insurance companies. As the state/regional laws could be subject to change, the new state/regional laws can be updated during the inspection when the computer in the vehicle is accessed via the communication port. In a preferred embodiment of the invention the log of failures to fasten seatbelts and seatbelt violations which are stored in non-volatile memory can be and retrieved and viewed by the user on a display screen of the vehicle, i.e., the display screen typically used for GPS and/or other functions.

FIG. 2 depicts another possible implementation of the present invention which is similar to implementation of FIG. 1 in every aspect except that the odometer/speedometer is replaced by a GPS receiver. In this implementation GPS receiver 102 supplies the geographic location, whereas the geographic location, is needed to determine whether the incidences of failure to fasten seatbelt are also in violation of the local law or the local does not require use of seatbelt. The table of the seatbelt laws which includes geographic locations and their seatbelt laws is saved in non-volatile memory 101 and is referred to in order to generate the log of seatbelt violations. Generation of such a log can be handled either by processor 104 or an external processor, e.g., DMV's computer which has all the updated seatbelt laws at different times. Yet when using a GPS receiver instead of odometer/speedometer is the system could potentially miss some of the incidences of seatbelt violation due to the absence of GPS signal at certain locations such as tunnels and covered parking.

Non-volatile memory 101 contains additional data, to what was described in connection to FIG. 1: (a) the applicable law for each locality, i.e., whether all the passenger or only the front passengers or none of the passengers are required to fasten seatbelts, (b) log of seatbelt violations with their associated times and travelled distances data for each seat.

FIG. 3 depicts another possible implementation of the present invention similar to implementation of FIG. 2 except that the location data are supplied by GPS receiver 102 and the travel data is provided by vehicle's odometer/speedometer. GPS receiver 102 is used for determining the geographic location of the vehicle while the failures to fasten seatbelt occur. In a system built according to FIG. 3, no failure of using seatbelt is lost as the travel data is supplied by the odometer/speedometer 100 and the system determines whether the failures to fasten seatbelt were violations of the local law or not, GPS receiver 102 supplies its collected data to processor 104. If the software for processor 104 has sufficient intelligence the logs of violations can be assessed. As the vehicle travels into a tunnel (or another form of covered area), the system uses the mileage record from odometer/speedometer 100. The system utilizes the data from GPS receiver 102 to determine the geographic location of the tunnel, and refers to the table of seatbelt laws stored in non-volatile memory 101 for the entry point to the tunnel. Subsequently, the system determines the total mileage travelled in the tunnel by using the data, from odometer/speedometer 100 and the system verifies the exit from the tunnel by using the data from supplied by GPS receiver 102.

FIG. 4 is a depiction of the front section of the interior of a vehicle which is equipped with overhead console 200 with 5 different warning lights corresponding to 5 seatbelts implemented above the rear view mirror. In this depiction, as a possible instance warning lights 201 and 202 are illuminated and the remaining lights are dark, indicating that seatbelts of the front right passenger and the rear middle are not fastened.

In addition to seatbelt warning lights overhead console 200 may be used for implementation of different vehicles utilities ( ). As an example, as depicted in FIG. 4, on the overhead console 200 a plurality of buttons 204 for a trainable garage door opener and a map lamp light 206 are implemented, whereas other utilities could possibly be implemented on overhead console 200.

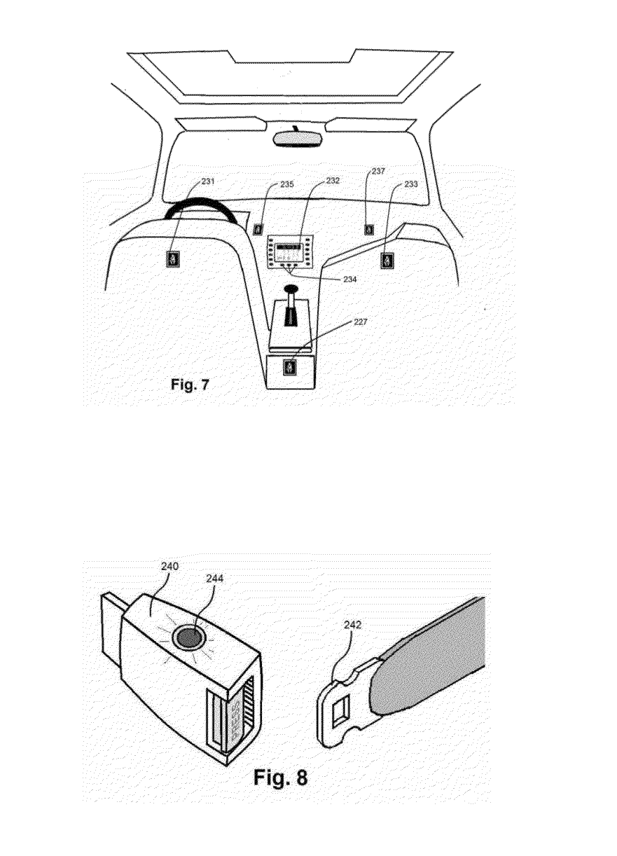

FIG. 5 depicts the interior of a vehicle equipped overhead consoles 220 and 228 and display screen 232. Overhead console 220 houses seatbelt warning lights for alerting passengers in the front seats is located above the rear view mirror at the front portion of vehicle's ceiling in the interior. Overhead console 228 houses three seatbelt warning lights for alerting passengers in the rear seats located approximately in the mid-ceiling. According a preferred embodiment of the present invention the end users of the vehicle, e.g., driver, owner or a passenger can access the log of the failures to fasten seatbelt and/or seatbelt violations. The same display utilized for GPS, car radio, CD player, camera, radar, etc, which could be shared for displaying the log of the failures to fasten seatbelt and/or seatbelt violations does not take resources and space. In FIGS. 1, 2, 3, 5, 6 and 7 reference to display screen 232 may be utilized for this purpose. In a typical implementation of display screens 232 touch screens access control is available, in addition to control keys on the periphery of the screen. In FIGS. 5, 6 and 7, a number of keys are depicted around display screen 232. Only a few keys, e.g., keys 234 are sufficient for accessing the logs seatbelt use failures/violations via display screen 232.

FIG. 6 depicts two consoles substituting for the console of FIG. 5. Console 221 located on the dashboard below the rear view mirror is used for alerting passengers in the front seats. Console 239 located at the rear portion of center console approximately in the middle of the ceiling is used for alerting passengers in the rear seats. In the depiction of FIG. 6 two warning lights are implemented on console 221 for two front passengers and three warning lights are implemented on console 239 for three rear passenger and each warning light is oriented towards the pertinent passenger.

FIG. 7 depicts alternative locations for seatbelt warning lights. In this depiction, seatbelt warning light 235 is implemented on the dashboard in the area in front of the driver seat for alerting the driver. Seatbelt warning light 237 is positioned on the dashboard in front of the passenger in the right front seat. Seatbelt warning lights 231 is positioned on the back of driver seat and is for alerting the passenger in the left rear seat. Seatbelt warning lights 233 is placed on the back of the right front seat and is for alerting the passenger in the right rear seat. Seatbelt warning light 227 is placed at the rear portion of center console is for alerting the passenger in the middle rear seat.

The design of seatbelt warning lights can be of an arbitrary pattern, e.g., round, square, or any appropriate figure, e.g., seatbelt, silhouette of a person wearing a seatbelt as in the depiction of FIGS. 4, 5, 6 and 7. In the depiction of FIGS. 5, 6, 7 each warning light is angled such that faces towards the pertinent passenger, e.g., in FIG. 5, seatbelt warning light 222 is facing toward the right front passenger.

Despite the warning lights in FIGS. 4, 5, 6, 7 depict interior an SUV or a sedan automobile, in the warning lights can be used in other types of motor vehicles such as, vans, trucks and buses.

FIG. 8 depicts another method for implementing seatbelt warning lights. Seatbelt receiver (buckle female piece) 240 houses seatbelt warning light 244. When the passenger occupancy sensor senses the presence of a passenger and seatbelt sensors senses that the seatbelt is not buckled, processor 104 turns on warning light 244. However, upon insertion of seatbelt tab (male piece) 242 into seatbelt receiver (female buckle piece) 240 the built-in seatbelt sensor changes its binary state, and subsequently, processor 104 turns off seatbelt warning light 244.

According to a preferred embodiment of the present invention, in the warning light discussed above (FIGS. 4, 5,6,7 and 8) a dual color illumination system for the warning lights is utilized. When violation of state/local seatbelt law occurs the warning light is illuminated with red color whereas when seatbelt is not used in the states/regions where use of seatbelt is not required, the warning light is illuminated with another color, e.g., yellow.

According to another embodiment, the blinking rate changes for the incidences of failure to use the seatbelt without violating the regional law and seatbelt violation. According to this embodiment a fast blinking warning light corresponds to seatbelt violation and slow blinking or solid illumination of the warning light corresponds to failure to use the seatbelt without violating the regional law.

According to a preferred embodiment of the present invention pulsating vibration (intermittent vibrating mechanism) is utilized for altering passengers to use their seatbelts. The vibrating mechanisms are placed in passenger seats or in the seatbelt receivers. To ensure that the vibrations are discernable by passengers who might sit or lean at different locations on the seat, a plurality of vibrating mechanism per passenger seat may be utilized. In order to distinguish between violation of regional seatbelt law versus merely failing to use the seatbelt without violating of seatbelt law, different pulsation frequencies are utilized. Several techniques for generating mechanical vibrations can be utilized, e.g., piezoelectric transducers, linear/rotation electromechanical transducers or vibration generating devices using shaped memory alloys such as Nitinol.

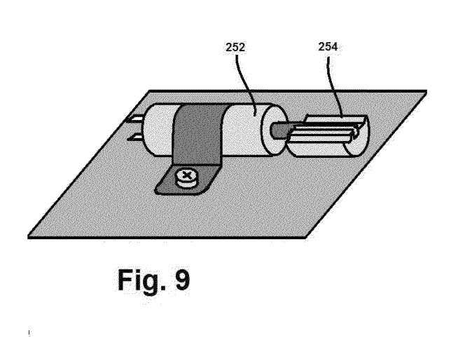

FIG. 9 depicts an implementation of a rotational electromechanical vibrating mechanism. In this implementation miniature electric motor 252 is used as the means for generating rotational motion. An off center counterweight, i.e., half cylinder 254 countering miniature electric motor 254, is connected to the axel of miniature electric motor 252 generating a vibrating motion to the surface that miniature electric motor 252 is attached to when miniature electric motor 252 turns. This mechanism or other vibrating mechanisms (e.g., piezoelectric transducers, speaker, linear electromechanical transducers) are installed in the seat or in the seatbelt receiver. Often times, using these mechanisms, the vibration might not be directly felt by the passenger, a buzzing sound can be heard.

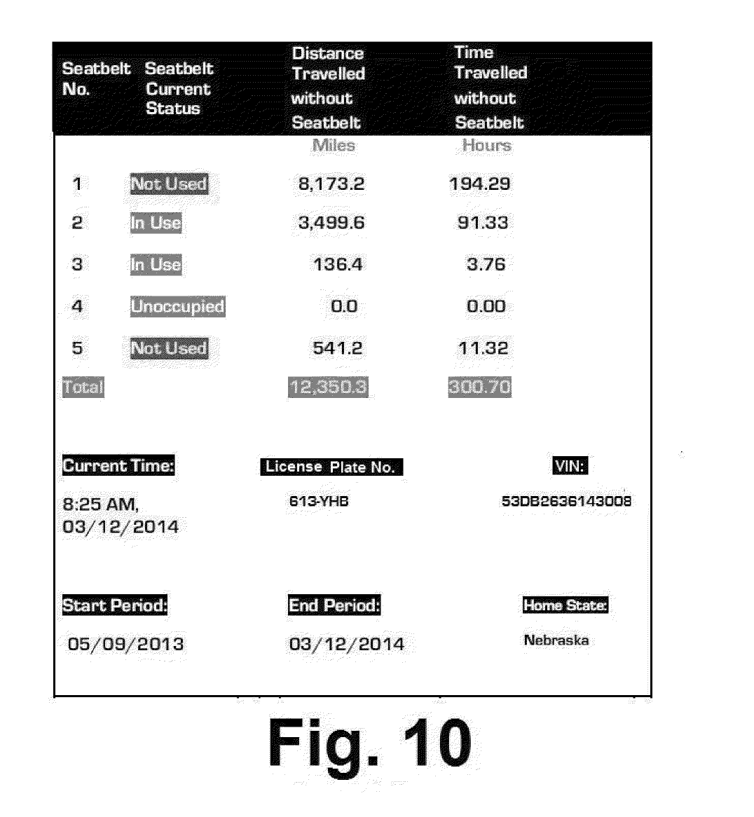

FIG. 10 depicts computer generated Status Report containing: (i) Vehicle's identification information. (ii) Travel log and time log for the incidences of failure to fasten seatbelt, the current status of seatbelts. (iii) Start Period. (iv) Current time. (v) Current status of seatbelts.

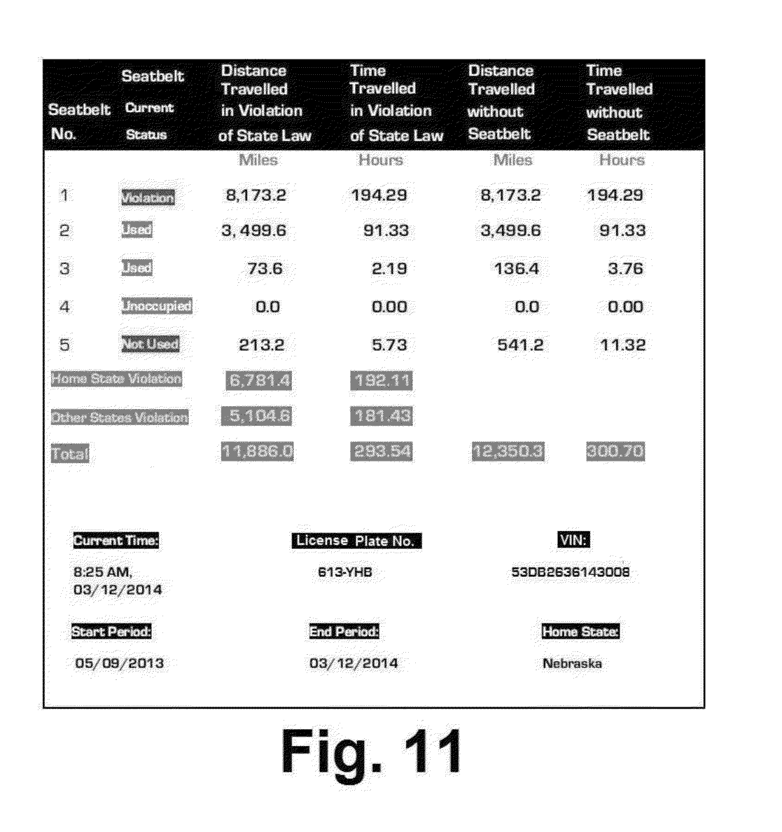

Vehicle's identification information is VIN (Vehicle Identification Number). License Plate Number, Home State, the state where the vehicle is registered at. The examples of FIGS. 10 and 11 refer to states. However, in different locations, depending on the geographic region, instead of “Home State”, “Home Country” or “Home Province” might be substituted. This information is entered into the system via the authorized personnel and can get changed when the ownership changes, owner moves to another state, license plate changes, etc.

Travel logs are generated by using the vehicle's odometer/speedometer in conjunction with occupancy and seatbelt sensors, i.e., a system described in the block diagram of FIG. 1 or a similar system. As depicted the logs of “Distance Travelled without Seatbelt” and “Time Travelled without Seatbelt” for each seatbelt and the total for the period of time between “Start Period” and “Current Time”.

Start Period, corresponds to the date when the system started for the first time or a subsequent time when the system was reset by the authorized personnel.

Current status of each of seatbelts (1 through 5) is displayed under “Seatbelt Current Status” column. The “seatbelt status” can be “Unoccupied”, i.e., there is no passenger detected on the seat, “In Use”, i.e., the seatbelt is fastened and “Not Used” i.e., there is a passenger detected by passenger occupancy sensor but seatbelt is not used.

FIG. 11 depicts computer generated Status Report which in addition to information included in FIG. 10 it contains two other columns “Distance Traveled in Violation of State Law” and “Time Traveled in Violation of State Law” for each seatbelt and their sums for Home State and other states are included. Additionally, Status Report of FIG. 11 under “Seatbelt Current Status” column the category of “Violation” is included.

Status Report of FIG. 11 is generated by a system similar to the depictions in FIGS. 2, 3 wherein a GPS receiver is utilized. The logs of distances and times of seatbelt violations are generated by means of a GPS receiver which determines the states and in turn the applicable seatbelt law, i.e., determining whether failures to use seatbelts were against the state laws.

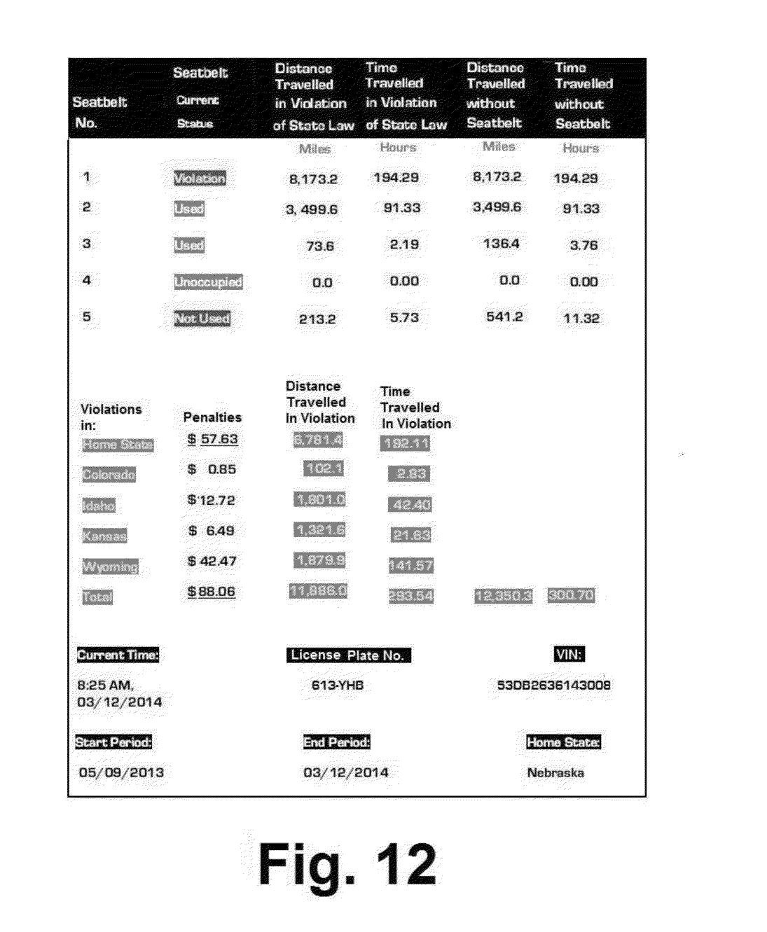

FIG. 12 depicts computer generated Status Report which in addition to information included in FIG. 11 it contains three other columns, the “Distance Travelled In Violation”, “Time Travelled In Violation” and calculated “Penalties” incurred for each of the states where seatbelt violations had occurred and the “Total”s are enumerated. The accrued penalties are calculated based on the Distance Travelled In Violation or Time Travelled In Violation or their combination, whereas, in the exemplary depiction of FIG. 12 the penalties are based on $0.30 per hour of seatbelt violation.

According to a preferred embodiment of the present invention, a Status Report such as described in FIGS. 10, 11, 12 and 13 is available on display screen 232 depicted in FIGS. 1, 2, 3, 5, 6 and 7 and can be viewed by user (passengers, driver, etc) in real time, i.e., as the vehicle travels the information gets updated on display screen 232. A hard copy or an electronic version of Status Report is accessible by the DMVs, insurance companies.

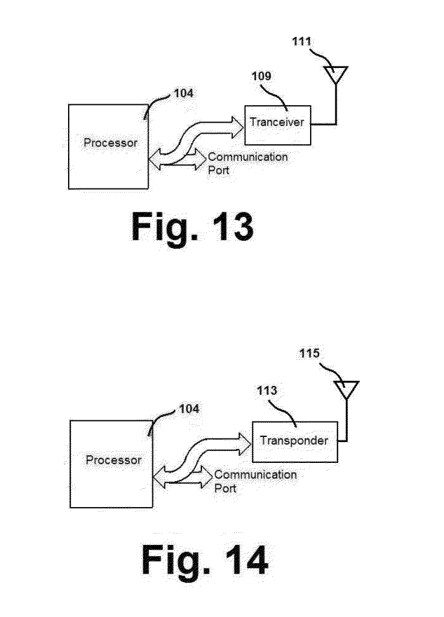

FIG. 13 depicts a fractional block diagram for the present invention with a wireless access option. Processor 104 depicted in FIGS. 1, 2 and 3 is the same processor 104 of this depiction, however for simplicity the other blocks and connections which appear in FIGS. 1, 2 and 3 are not shown in this depiction. Transceiver 109 is connected to processor 104 via a bus connection or communication port. Transceiver 109 is connected to antenna 111 for reception and transmission of radio frequency signals. Transceiver 109 could be a transceiver used in cellular or satellite phones through which communication is established via cellular networks and/or satellites. Hence by addition of transceiver 109 and antenna 111 to the systems described in FIG. 1, 2 or 3, the Status Reports can be accessed remotely. In a possible scenario, utilizing transceiver 109 and antenna 111, processor 104 sporadically establishes communications through cellular network and access DMV's and/or insurance companies' computers in order to update the Status Reports. Consequently, DMV sends statements/invoices to the registrant either periodically or after the accrued penalties exceeds certain threshold. Likewise, the insurance companies have the seatbelt usage data of the vehicle at the time of renewing the insurance policies. As a result of this embodiment of the present invention, there would not be any needs for taking the vehicle to special stations.

To add more prominence when the passengers are not using their seatbelts it is preferred to use a different color, e.g., red, with blinking that the two statuses of “Unused” or “Violation” under the column “Current Status” in depictions of FIGS. 11, 12 and 13.

FIG. 14 depicts a fractional block diagram for the present invention with a transponder access option. In the depiction, processor 104 corresponds to the same processor 104 depicted in FIGS. 1, 2 and 3, however, for the purpose of simplicity, other blocks and connections which appear in FIGS. 1, 2 and 3 are not shown in this depiction. Transponder 113 is connected to processor 104 via bus connection and or communication port. Transponder 113 and antenna 115 to the systems described in FIG. 1, 2 or 3, enable remote access to Status Reports which was described above. According to this embodiment of the present invention, the Status Reports are accessed by the police, inspection stations, insurance companies and DMVs who are equipped with beacon transmitters. In a preferred embodiment, transponders in different vehicles produce orthogonal or quasi-orthogonal signals such as Code Division Multiple Access (CDMA). Hence when the police's beacon transmitter sends an interrogation signal, the simultaneous replies from all the nearby vehicles can be processed simultaneously without interference. Consequently, the police can view multiple nearby vehicles' “Plate Number” and “Seatbelt Status” as described in FIGS. 11 and 12 and issue summons to the drivers of those vehicles who are in violation of seatbelt law.

Depending on the complexity of the system implemented in the vehicle, when the vehicle is accessed by inspection stations, insurance companies and DMVs a reply similar to reports of FIG. 10, 11 or 12 is generated.

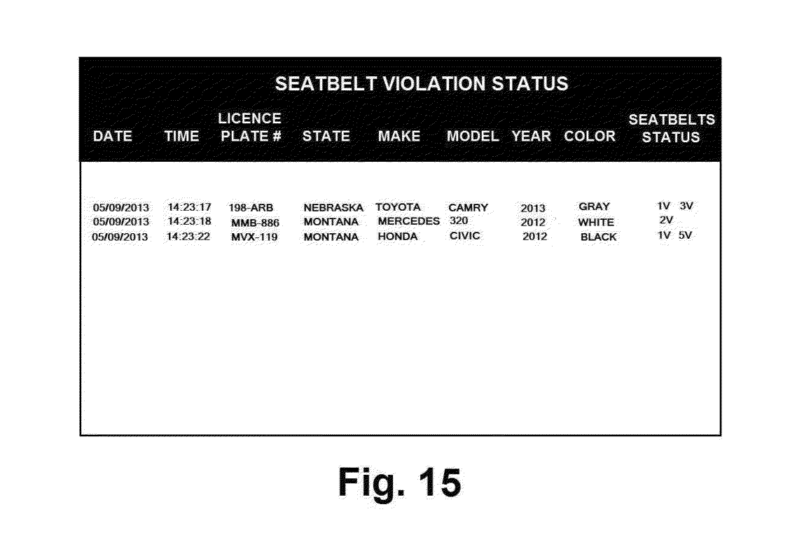

FIG. 15 depicts a typical report generated by police's beacon radar which is described in FIG. 14. This report is generated by collecting the transponder replies from the nearby vehicles and is displayed on the display screen in police's vehicles. The displayed information included in the replies is: “Date”, “Time”, “License Plate Number”, “State”, “Make (of the vehicle)”, “Model”, “Year (of the vehicle)”, “Color” and “Seatbelt Status”. According to a preferred embodiment, in order to avoid overcrowding the display screen, only the replies that include seatbelt violations are displayed. “Make”, “Model”, “Year” and “Color” are utilized to assists the police to identify the vehicles that their passengers are not complying with the seatbelt laws.

What is claimed:

1. A system for logging failures of using seatbelts by occupants of a motor vehicle, said system comprising:
a digital processor;
a non-volatile memory;
an odometer/speedometer;
a clock circuit;
seatbelt sensors; and
passenger occupancy sensors data,
wherein said digital processor utilizes data from said odometer/speedometer for determining the distances travelled by said motor vehicle while occupants were not using seatbelts,
wherein said non-volatile memory is configured to record logs for said failures,
wherein said digital processor utilizes data from said clock circuit for counting the total times while one or more occupants were not using their seatbelts,
and wherein said odometer/speedometer verifies that said failures occurred while said motor vehicle was in motion.

2. The system according to claim 1, wherein said odometer/speedometer is replaced with a GPS receiver and said digital processor utilizes data from said GPS receiver to determine the vehicle distance while occupants were not using seatbelts and the time while occupants were not using seatbelts were in violation of the local seatbelt laws of said region in which said motor vehicle was present when said violations occurred.

3. The system according to claim 1, wherein said odometer/speedometer is replaced with a GPS receiver, and where said non-volatile memory is additionally utilized for storing applicable seatbelt laws for different local laws, said processor utilizing said stored seatbelt laws and GPS data to verify whether said failures were violation of local said laws for additionally generating logs of seatbelt violations.

4. The system according to claim 1, wherein in addition to said odometer/speedometer, a GPS receiver is utilized, wherein said non-volatile memory is utilized for storing applicable seatbelt laws for different local laws, and where said processor utilizes said stored seatbelt laws and GPS data to verify whether said failures were violation of local said laws for additionally generating logs of seatbelt violations.

5. The system according to claim 1, wherein said system generates a report in real time, said report is accessible on a screen display, via a communication port, or via wireless access, said report configured to include any one status selected from the group consisting of:
seatbelt current status for each of seatbelts in said motor vehicle,
whether each seatbelt is “in use” or “not used.”
a “start period” and an “end period,” indicating the beginning and end periods for inclusion of failures to use seatbelt in said report,
“distance travelled without use of seatbelt” for each seatbelt,
“time travelled without seatbelt without use of seatbelt for each seatbelt”
the accumulated “totals” for all seatbelts for both “distance travelled without use of seatbelt” for each seatbelt, and “time travelled without seatbelt without use of seatbelt for each seatbelt”, and
the “current time” and identification information concerning said motor vehicle, i.e., “license plate number”, “VIN” and “home state.”

6. The system according to claim 2, wherein said system is configured to generate a report in real time, said report being accessible on a screen display, via a communication port, or being accessible wirelessly, said report includes anyone status selected from the group consisting of:
a seatbelt current status for each of seatbelts in said motor vehicle, indicating whether each seatbelt is “in use” or “not used”;
a “start period” and an “end period,” indicating the beginning and end periods for inclusion of failures to use seatbelt;
a “distance travelled in violation of local law” for each seatbelt;
a “time travelled in violation of local law for each seatbelt”;
a “distance travelled without use of seatbelt” for each seatbelt;
a “time travelled without seatbelt without use of seatbelt” for each seatbelt;
an accumulated “totals” for all seatbelts for both “distance travelled without use of seatbelt” for each seatbelt, and “time travelled without seatbelt without use of seatbelt for each seatbelt”;
a “current time” and identification information concerning said motor vehicle, including “license plate number,” “VIN” and “home state.”

7. The system according to claim 6 wherein said report further includes accrued penalties for seatbelt violation, wherein said penalties are computed based on “distance travelled in violation of local law” or “time travelled in violation of local law for each seatbelt,” or a combination of both.

8. The system according to claim 1, further comprising wireless access for said system accomplished via cellular networks or satellite.

9. The system according to claim 1, further comprising wireless access for said system accomplished via a transponder, wherein a beacon transmitter transmits an interrogation signal, and said system replies with a report.

10. The system according to claim 9, wherein replies from different motor vehicles are orthogonal or quasi orthogonal and can be process replies from different vehicles independently.

11. An alert system for occupants of a motor vehicle, to be viewed by occupants of the vehicle, wherein for each occupant, a designated warning light is utilized to indicate failure to use seatbelts by said occupants.

12. The alert system as claimed in claim 11, wherein said warning lights are on an overhead console located in a front of the interior of said motor vehicle

13. The alert system as claimed in claim 11, wherein said warning lights are on a plurality of overhead consoles located in a front of each row of said motor vehicle's interior, to be viewed by occupants of each of said rows.

14. The alert system as claimed in claim 11, wherein said warning lights are on a plurality of non-overhead consoles located in a front of each row of said motor vehicle's interior, to be viewed by occupants of each of said rows.

15. The alert system as claimed in claim 11, wherein said warning lights are on a plurality of consoles located directly in front of said occupants.

16. The alert system as claimed in claim 11, wherein said warning lights are on a plurality of consoles located on the seatbelt receiver of said occupants.

17. The alert system as claimed in claim 11, wherein said warning lights produce different colors based on if failure of using seatbelt is in violation of local seatbelt law or not.

18. The alert system as claimed in claim 11, further comprising a sound alert system for alerting each individual passenger of a motor vehicle who is not using seatbelt, said sound alerting system plays messages wherein a human voice is used for alerting passengers, such messages identifying the passenger's location who is not using seatbelt by the seat location, and further informs the passenger when the failure of using seatbelt is in violation of local seatbelt law.

19. The alert system as claimed in claim 11, further comprising a vibrate alerting system using mechanical vibrations for alerting each individual passenger of a motor vehicle who is not using seatbelt.

20. The alert system as claimed in claim 19, wherein said vibrate alerting system uses a mechanism of generating mechanical vibrations implemented in the seats of the vehicle.

21. The alert system as claimed in claim 19, wherein said mechanism of generating mechanical vibrations are implemented in the seatbelt receivers of the vehicle.

22. The alert system as claimed in claim 19, wherein for each individual passenger, different types of intermittent vibrations are utilized to inform the passenger when the failure of using seatbelt is not in violation of local seatbelt law and when the failure of using seatbelt is in violation of local seatbelt law.
